(19) United States
(12) Patent Application Publication
(10) Pub. No.: US 2012/0250450 A1
(43) Pub. Date: Oct. 4, 2012

(54) EXTERNAL MIXING DEVICE

(76) Inventors: Lewis Ho, Waterford, CT (US); King-Ming Chang, Hsin-Chu (TW)

(21) Appl. No.: 13/436,126

(22) Filed: Mar. 30, 2012

Related U.S. Application Data
(60) Provisional application No. 61/457,467, filed on Apr. 1, 2011.

(51) Int. Cl. B01F 15/02

(52) U.S. Cl. 366/132; 366/136

(57) ABSTRACT

An external mixing device comprises: arranging an inlet and an outlet on the single-use container; a sterilizable or a single-use pump head connected to the inlet and outlet with a mixer installed inside. Driven by a driving device, the mixer makes the liquid circulate continuously between the pump head and the single-use container. The external mixing device further comprises a sensor chamber installed with a plurality of sensors and extra ports, which are used for introducing solution or gas inside or for sampling and detecting liquid properties. A single-use connector is used to connect the single-use container to the external mixing device, which can be operated aseptically under general environment. The external mixing device is small-sized with the advantage of simplified operation procedures.

### BACKGROUND OF THE INVENTION

1. Field of the Invention

The present invention relates to a liquid homogenization device, and more particularly to a mixing device combining with an external driving device and a single-use container.

2. Description of the Prior Art

Single-use products have become popular for pharmaceutical industries because of reducing costs, ability of mass production and there is no concern about cleaning validation. Most manufacture process of pharmaceutical solutions and suspensions on an industrial scale is highly controlled. After mixing raw materials, uniform distribution of ingredients in the final product is required to achieve satisfactory yield. Thus, mixing devices are essential during certain manufacture process especially for single-use mixing devices because moving parts of traditional mixing devices may generate particles due to abrasion, which may contaminate the products or damage the containers and thus causes failure or risks during operation.

Rocking or rotating agitator tanks are frequently used to mix raw materials, but better mixing effects can be achieved by using mechanical stirrers or impellers. For single-use mixing systems, stirrers or impellers have to be installed inside the mixing containers and external driving devices are necessary to drive them, which makes systems complex and expensive. Therefore, peristaltic pumps are adopted to let liquid circulate through external pipelines. However, it generates various problems such as slow flow rate may limit mixing capability or vessels may be worn out to cause risks of leakage and contamination, and limited operation time for mixing. Thus, design of peristaltic pump is not suitable for large scale or long term use.

Besides, various kinds of sensors such as thermocouples, pH, conductivity or dissolved oxygen (DO) probes are usually incorporated into the mixing vessels or containers to control the mixing process. In some occasions, injecting alkaline, acid, concentrated solutions or for sampling the liquid are required during the process, hence a variety of inlet/outlet ports is required and the position of the ports in relative to the mixing device is crucial. Assembling multiple sensors into the mixing vessel especially for the single-use vessel is tedious and increasing the risks of contamination. Non-invasive sensors are developed but are still in developing stage, and more expensive compared with traditional sensors.

Therefore, an external mixing device which incorporates traditional sensors, inlet/outlets and a single-use centrifugal pump is developed, which can connect to a conventional mixing container or bag without structural limitation and is free from problems of vessel wear. The sensor and sampling module which incorporates a plurality of sensors and ports can reduce the risk of assembling mistake and contamination.

### SUMMARY OF THE INVENTION

The present invention is directed to an external mixing device which can connect to a single-use container, wherein the mixing device is a centrifugal pump with an autoclavable or single-use pump head arranged thereon; the pump head with a magnetic impeller installed inside is a completely closed system. A sensor chamber is arranged in the external mixing device. There are a plurality of sensors and extra ports arranged on the sensor chamber for introducing solution and gas inside or for sampling and detecting liquid properties. Furthermore, connectors between the single-use container and the external mixing device are ready-to-use or single-use connectors, which allows sterile connection under general environment. The external mixing device is small-sized with the advantage of simplified operation.

According to an embodiment, the external mixing device is used to mix a liquid in a single-use container. The external mixing device comprises: arranging an inlet and an outlet on the single-use container; a static mixer is optionally chosen to be arranged in the single-use container; a pump head with a mixer installed inside comprising an intake and an outtake, wherein the outtake connects to the inlet of the single-use container and the intake connects to the outlet of the single-use container; the single-use container and the pump head are packed together and sterilized by Gamma ray irradiation or other means to become a ready-to-use set of mixing container. When performing mixing, a driving device is connected to the pump head to drive the mixer so as to let the liquid continuously circulate between the pump head and the single-use container.

According to another embodiment, the external mixing device is used to mix a liquid in a single-use container, wherein the external mixing device comprises: arranging an inlet and an outlet on the single-use container, wherein an inlet pipeline and an outlet pipeline are respectively arranged on the inlet and outlet, and a first single-use connector and a second single-use connector are arranged on the end away from the single-use container of the inlet and outlet; a pump head set which can be sterilized by autoclave comprising a pump head with a mixer installed inside, wherein the pump head comprises an intake and an outtake; a third single-use connector arranged on the intake of the pump head for connecting the second single-use connector of the single-use container; and a fourth connector arranged on the outtake of the pump head for connecting the first single-use connector of the single-use container so as to connect the single-use container and the pump head via the inlet pipeline and the outlet pipeline. The single-use container is packed independently and is sterilized by Gamma ray irradiation or other means. The pump head set comprises two single-use connectors which are arranged on the two ends of the pump head and can be sterilized by autoclave. When performing mixing, a driving device is connected to the pump head after connecting the single-use connector of the single-use container to the single-use connector of the pump head to drive the mixer so as to let the liquid continuously circulate between the pump head and the single-use container. The single-use connectors of the pump head set can be removed and replaced by new single-use connectors after use to become a new pump head set. The set is reusable after sterilization.

According to another embodiment, the external mixing device is used to mix a liquid in a single-use container, wherein the external mixing device comprises: arranging an inlet and an outlet on the single-use container, wherein an inlet pipeline and an outlet pipeline are respectively arranged on the inlet and outlet, and a first single-use connector and a second single-use connector are arranged on the end away from the single-use container of the inlet and outlet; a module comprising a pump head with a mixer installed inside, wherein the pump head comprises an intake and an outtake; a sensor set comprising a sensor chamber, wherein the sensor chamber connects a testing inlet pipeline and a testing outlet pipeline and the testing inlet pipeline is attached to the outtake; a third single-use connector is arranged on the intake for connecting the second single-use connector; and a sixth single-use connector is arranged on one end away from the sensor chamber of the testing outlet pipeline for connecting the first single-use connector and further connects the pump head, sensor chamber and the single-use container; and a driving device connected to the pump head to drive the mixer so as to let the liquid continuously circulate between the pump head and the single-use container.

Continue the above description, the single-use container is packed independently and is sterilized by Gamma ray irradiation or other means. The module comprising pump head set and the sensor set can be sterilized by autoclave. When performing mixing, a driving device is connected to the pump head after connecting the single-use connector of the single-use container to the single-use connector of the pump head to drive the mixer so as to let the liquid continuously circulate between the pump head, the sensor chamber and the single-use container. The single-use connectors of the module can be removed and replaced by new single-use connectors after use to become a new module. The module is reusable after sterilization.

According to another embodiment, the external mixing device is used to mix a liquid in a single-use container, wherein the external mixing device comprises: arranging at least an inlet and an outlet on the single-use container, wherein an inlet pipeline and an outlet pipeline are respectively arranged on the inlet and outlet, and a first single-use connector is arranged on one end of the inlet pipeline; a pump head with a mixer installed inside, wherein the pump head comprises an intake and an outtake; a fourth single-use connector arranged on the intake of the pump head and the intake of the pump head attached to the outlet pipeline, for forming a module; a sensor set comprising a sensor chamber connecting a testing inlet pipeline and a testing outlet pipeline; a fifth single-use connector arranged on the end of the testing inlet pipeline for connecting the first single-use connector and a sixth connector arranged on the end of the testing outlet pipeline for connecting the first single-use connector; and a driving device connected to the pump head to drive the mixer so as to let the liquid circulate between the pump head, the sensor chamber, and the single-use container.

Continue the above description, the single-use container and the single-use pump head are assembled together and packed and are sterilized by Gamma ray irradiation or other means. After combining the sensor chamber with sensors, the whole chamber with the single-use connectors on two ends of the chamber are sterilized by autoclave. When performing mixing, a driving device is connected to the pump head after connecting the single-use connector of the module and the single-use connector of sensor set to drive the mixer so as to let the liquid continuously circulate between the pump head, the sensor chamber and the single-use container. The single-use connectors of the sensor set can be removed and replaced by new single-use connectors after use to become a new set. The sensor set is reusable after sterilization.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram illustrating the external mixing device according to a first embodiment of the present invention;

FIG. 2 is a schematic diagram illustrating disassembling the external mixing device according to a second embodiment of the present invention;

FIG. 3 is a schematic diagram illustrating assembling the external mixing device according to the second embodiment of the present invention;

FIG. 4 is a schematic diagram illustrating disassembling the external mixing device according to a third embodiment of the present invention;

FIG. 5 is a schematic diagram illustrating assembling the external mixing device according to the third embodiment of the present invention;

FIG. 6 is a schematic diagram illustrating disassembling the external mixing device according to a fourth embodiment of the present invention;

FIG. 7 is a schematic diagram illustrating assembling the external mixing device according to the fourth embodiment of the present invention;

FIG. 8 is a top view diagram schematically illustrating mixing status of the external mixing device and flowing status of the liquid;

FIG. 9 is a schematic diagram illustrating conductivity of the solution against time by operating the external mixing device under different flow rate;

FIG. 10 is a schematic diagram illustrating the external mixing device operated under different flow rate in the mixing test;

FIG. 11 is a schematic diagram illustrating conductivity of the solution against time by operating the external mixing device with different position of inlets; and

FIG. 12 is a schematic diagram illustrating the external mixing device operated with different position of inlets in the mixing test.

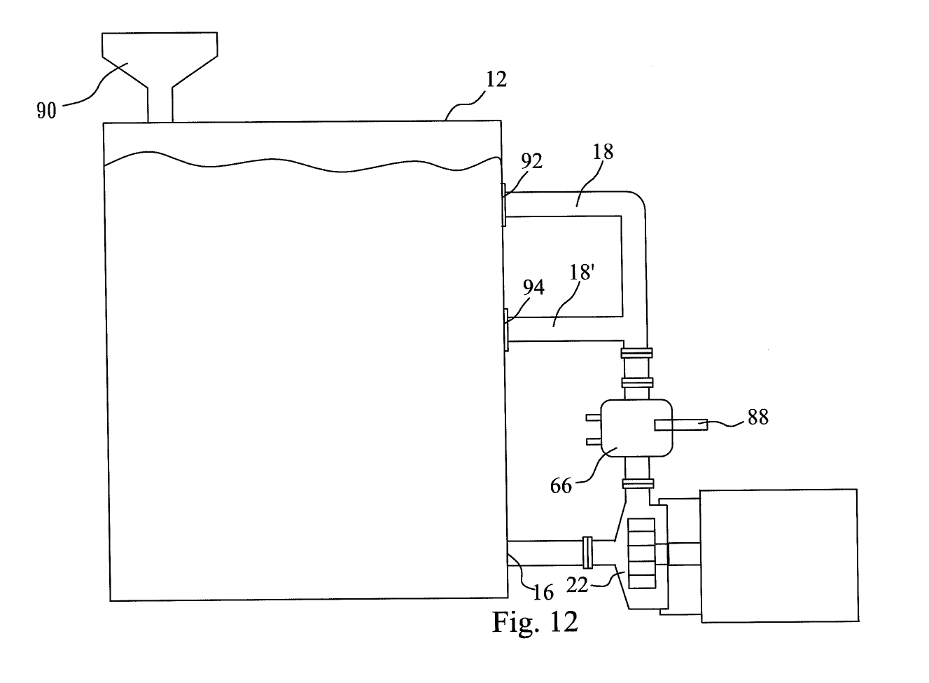

### DESCRIPTION OF THE PREFERRED EMBODIMENT

The detail description is provided below and the preferred embodiments described are only for the purpose of description rather than for limiting the present invention.

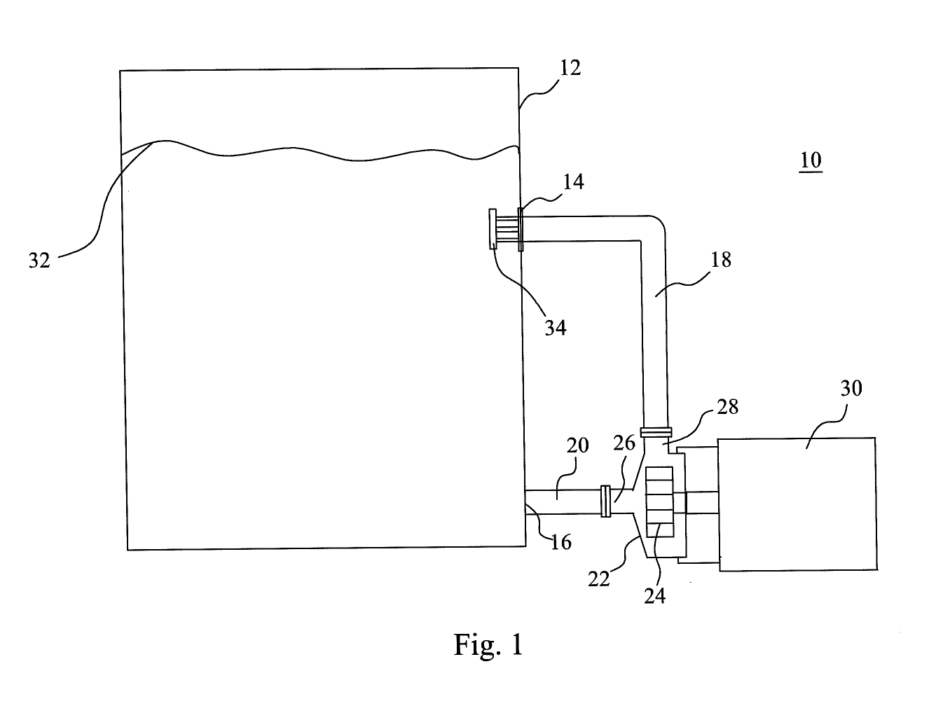

Referring to FIG. 1, the external mixing device according to a first embodiment is used to mix a liquid in a single-use container, wherein the single-use container can be a bag. As illustrated in FIG. 1, The external mixing device 10 comprises: arranging an inlet 14 and an outlet 16 on the single-use bag 12, wherein the inlet 14 and the outlet 16 are respectively attached to an inlet pipeline 18 and an outlet pipeline 20; a centrifugal pump head 22 with an impeller 24 installed inside comprising an intake 26 and an outtake 28, wherein the intake 26 connects to the outlet pipeline 20 of the single-use bag 12 and the outtake 28 connects to the inlet pipeline 18 of the single-use bag 12 for attaching the pump head 22 to the bag 12; and a driving device, in one embodiment, the driving device is a magnetic bearingless motor 30, connected to the centrifugal pump head 22 to drive the impeller 24. By driving the impeller 24, mixing effect is achieved by continuous circulation that the liquid 32 in the bag 12 is transmitted through the outlet pipeline 20 and the pump head 22 to the inlet pipeline 18. A static mixer 34 is optionally chosen to be arranged inside the bag 12 next to the inlet 14 to enhance mixing effect by generating vortex.

According to the first embodiment, the bag 12 and the centrifugal pump head 22 are packed together and sterilized by Gamma ray irradiation or other means to become a ready-to-use set of mixing container. When performing mixing, the magnetic bearingless motor 30 is connected to the pump head 22 to drive the impeller 24 so as to let the liquid 32 continuously circulate between the pump head 22 and the bag 12. The bag 12 and the centrifugal pump head 22 are for single-use and the external mixing device 10 further comprises a holder (not shown in the figure) to support the bag 12.

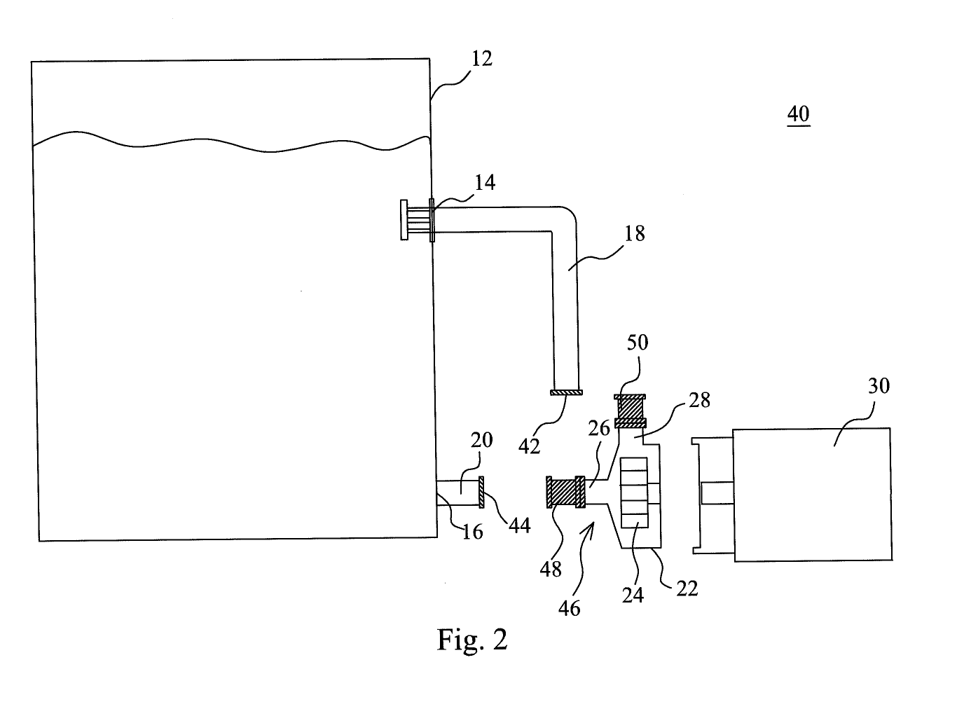

Referring to FIG. 2, the external mixing device 40 according to a second embodiment comprises: arranging an inlet 14 and an outlet 16 on the bag 12, wherein the inlet 14 and the outlet 16 are respectively attached to an inlet pipeline 18 and an outlet pipeline 20; a first single-use connector 42 and the second single-use connector 44 arranged on the ends away from the bag 12 of the inlet pipeline 18 and outlet pipeline 20. In one embodiment, the first single-use connector 42 and the second single-use connector 44 are single-use flexible tube connectors.

A pump head set 46 comprises a centrifugal pump head 22, a third single-use connector 48 and a fourth single-use connector 50. In one embodiment, the third single-use connector 48 and the fourth single-use connector 50 are single-use sanitary flange connectors. The centrifugal pump head 22 with an impeller 24 installed inside comprises an intake 26 and an outtake 28, and the third single-use connector 48 and the fourth single-use connector 50 are arranged on the intake 26 and the outtake 28; and a driving device, in one embodiment, the driving device is a magnetic bearingless motor 30 connected to the centrifugal pump head 22 to drive the impeller 24.

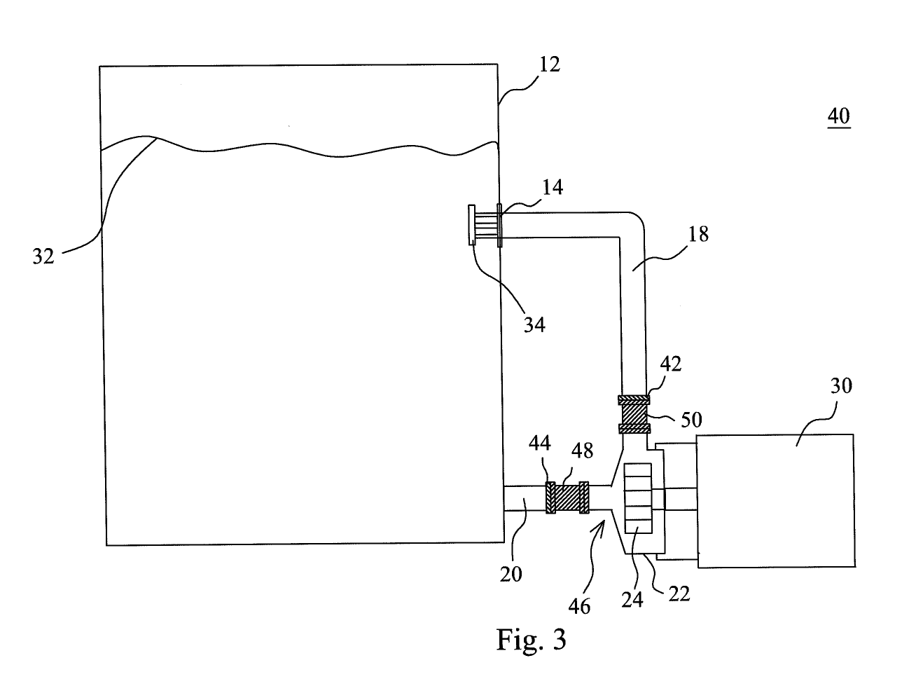

Referring to FIG. 3 according to the second embodiment of the present invention, the fourth single-use connector 50 of the pump head set 46 is connected to the first single-use connector 42 to connect the inlet pipeline 18 and the third single-use connector 48 of the pump head set 46 is connected to the single-use connector 44 to connect the outlet pipeline 20 and further connects the bag 12 and the centrifugal pump head 22. By driving the impeller 24, mixing effect is achieved via continuous circulation that the liquid 32 in the bag 12 is transmitted from the outlet pipeline 20 through the centrifugal pump head 22 to the inlet pipeline 18. A static mixer 34 is optionally chosen to be arranged inside the bag 12 next to the inlet 14 to enhance mixing effect by generating vortex.

In the second embodiment, the first single-use connector 42, the second single-use connector 44, the third connector 48 and the fourth single-use connector 50 are single-use flexible tube/sanitary flange connectors, for example, ReadyMate Disposable Aseptic connector of GE Healthcare or Kleenpak sterile connectors of Pall Corporation. Before using the single-use connectors, openings of the connectors are sealed with films to prevent external contamination. After connecting two single-use connectors, films are removed. By this way, single-use connectors can connect other parts sterilely under general environment. In this embodiment, the single-use flexible tube connector is connected to the single-use sanitary flange connector so as to connect inlet pipeline/outlet pipeline and the centrifugal pump head. Also, the single-use connector can be sterilized by autoclave or sterilized by Gamma ray irradiation before using it and thus it can be jointly connected to other parts for sterilization.

Continue the above description, the bag 12 is independently packed and sterilized by Gamma ray irradiation or other means. Before connecting the centrifugal pump head 22 to the magnetic bearingless motor 30, the whole pump head set 46 is sterilized by 25˜50 kGy gamma radiation or 121° C. autoclaved for 30 minutes. After sterilizing the pump head set 46, the pump head set 46 is connected to the inlet pipeline 18/outlet pipeline 20 of the bag 12 and the pump head 22 is connected to the magnetic bearingless motor 30. After this, fill the bag 12 with liquid and turn on the motor 30 to mix the liquid 32. The single-use connectors of the pump head set can be removed and replaced by new single-use connectors after use to become a new pump head set. The set is reusable after sterilization. For those procedures which are not necessary operated under sterile environment, single-use connectors are not required to connect the centrifugal pump head 22 and the bag 12. The external mixing device 40 further comprises a holder (not shown in the figure) to support the bag 12 and the pump head set 46.

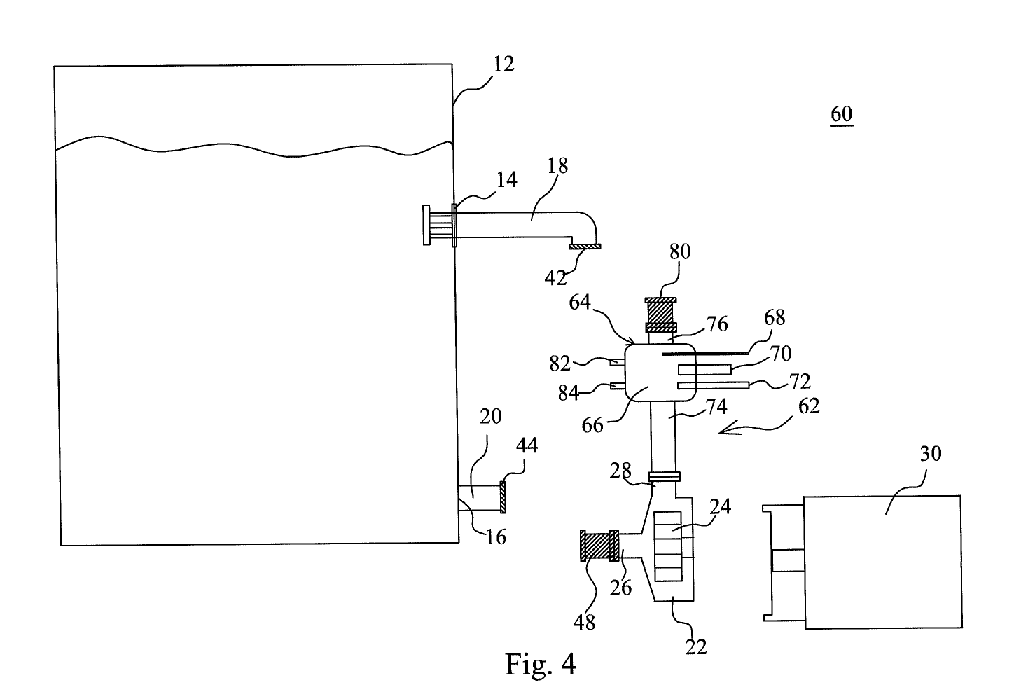

Referring to FIG. 4 according to the third embodiment of the present invention, the external mixing device 60 comprises: arranging an inlet 14 and an outlet 16 on the bag 12, wherein the inlet 14 and the outlet 16 are respectively attached to an inlet pipeline 18 and an outlet pipeline 20, and a first single-use connector 42 and the second single-use connector 44 are arranged on the ends away from the bag 12 of the inlet pipeline 18 and outlet pipeline 20. In one embodiment, the first single-use connector 42 and the second single-use connector 44 are single-use flexible tube connectors.

A module 62 comprises a centrifugal pump head 22, a sensor set 64, a third single-use connector 48 and a sixth single-use connector 80. In one embodiment, the third single-use connector 48 and the sixth single-use connector 80 are single-use sanitary flange connectors.

Continue the above description, the centrifugal pump head 22 with an impeller 24 installed inside comprises an intake 26 and an outtake 28; the sensor set 64 comprises a sensor chamber 66 for installing one of the thermocouple 68, DO sensor 70, pH sensor 72 and conductivity meter (not shown in the figure) or combination thereof. The sensor chamber 66 connect a testing inlet pipeline 74 and a testing outlet pipeline 76, wherein the testing inlet pipeline 74 is attached to the outtake 28 of the centrifugal 22, the third single-use connector 48 is arranged on the intake 26 of the pump head 22 and the sixth single-use connector 80 is arranged on the end of the testing outlet pipeline 76. A driving device is used to drive the centrifugal pump head 22, in one embodiment, the driving device is a magnetic bearingless motor 30.

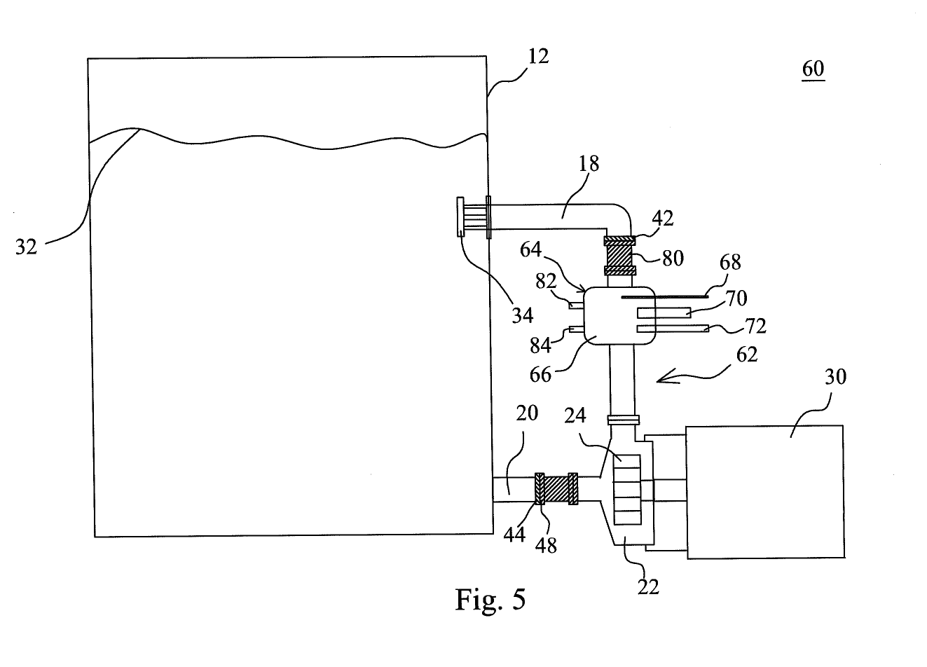

Referring to FIG. 5 according to a third embodiment of the present invention, the module 62 connects the second single-use connector 44 via the third single-use connector 48 and the sixth single-use connector 80 is connected to the first single-use connector 42 so as to connect the module 62 and the bag 12, wherein the centrifugal pump head 22 is connected to the magnetic bearingless motor 30 to drive the impeller 24. By driving the impeller 24, mixing effect is achieved via continuous circulation that the liquid 32 in the bag 12 is transmitted from the outlet pipeline 20 through the pump head 22 and the sensor set 64 to the inlet pipeline 18. A static mixer 34 is optionally chosen to be arranged inside the bag 12 next to the inlet 14 to enhance mixing effect by generating vortex.

In the third embodiment, various kinds of sensors such as thermocouple 68, DO sensor 70, pH sensor or conductivity meter are installed in the sensor chamber for detecting liquid properties. Additionally, there is a plurality of extra ports arranged on the sensor chamber 66 for the sampling port 82 and fluid port 84 so as to sample or transmit liquid/gas in the sensor chamber 66.

Continue the above description, the first single-use connector 42, the second single-use connector 44, the third connector 48 and the sixth single-use connector 80 are single-use flexible tube/sanitary flange connectors, for example, ReadyMate Disposable Aseptic connector of GE Healthcare or Kleenpak sterile connectors of Pall Corporation. Before using the single-use connectors, openings of the connectors are sealed with films to prevent external contamination. After connecting two single-use connectors, films are removed. By this way, single-use connectors can connect other parts sterilely under general environment. In this embodiment, the single-use flexible tube connector is connected to the single-use sanitary flange connector so as to connect the inlet pipeline/outlet pipeline and the centrifugal pump head. Also, the single-use connector can be steam sterilization or sterilized by Gamma ray irradiation before using it and thus it can be jointly connected to other parts for sterilization.

Continue the above description, the single-use container is independently packed and sterilized by Gamma ray irradiation or other means. Before connecting the centrifugal pump head 22 to the magnetic bearingless motor 30, the whole module 62 is steam sterilized by autoclaves. After sterilizing the module 62, the single-use container 12 is connected with the module 62. The pump head 22 is connected to magnetic bearingless motor 30. After this, fill the bag 12 with liquid 32 and turn on the motor 30 to mix the liquid 32. The single-use connectors of the module 62 can be removed and replaced by new single-use connectors after use to become a new module. The module is reusable after sterilization.

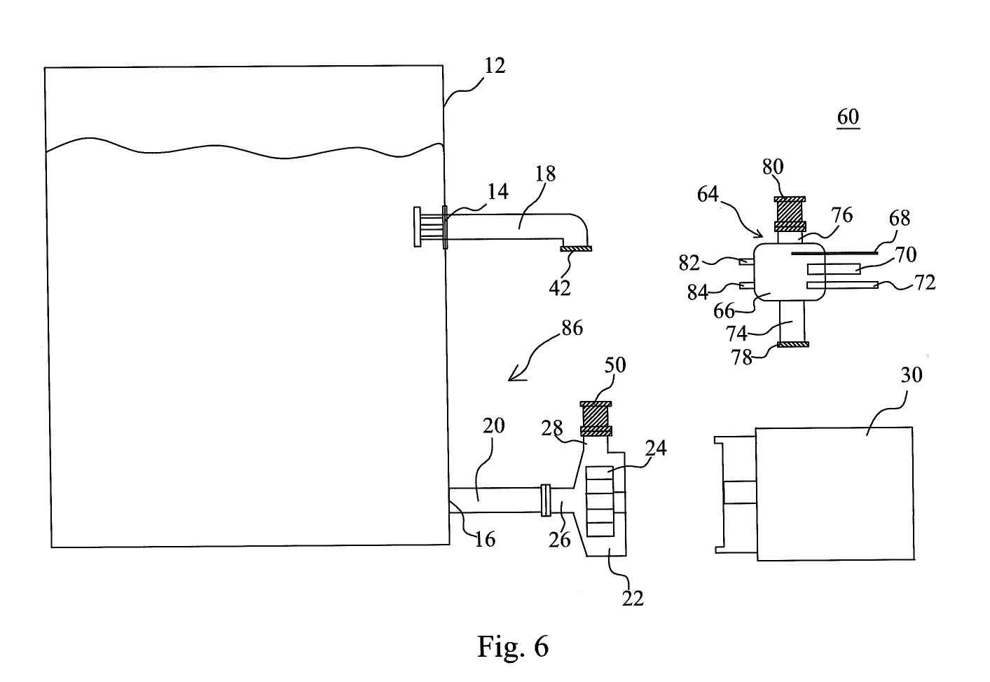

Referring to FIG. 6 according to a fourth embodiment of the present invention, a external mixing device 60 comprises: arranging an inlet 14 and an outlet 16 on the bag 12, wherein the inlet 14 and the outlet 16 are respectively attached to an inlet pipeline 18 and an outlet pipeline 20, and a first single-use connector 42 is arranged on the end of the inlet pipeline 18. In one embodiment, the first single-use connector 42 is a single-use flexible tube connector.

An outtake 26 of a centrifugal pump head 22 is attached to the end of the outlet pipeline to form a module 86 and a fourth single-use connector 50 is arranged on the outtake 28 of the centrifugal pump head 22. In one embodiment, the fourth single-use connector is a single-use sanitary flange connector.

A sensor set comprises a sensor chamber connecting a testing inlet pipeline 74 and a testing outlet pipeline 76, wherein a fifth single-use connector 78 is arranged on the end of the testing inlet pipeline 74 and a sixth single-use connector 80 is arranged on the end of the testing outlet pipeline 76. In one embodiment, the fifth single-use connector 78 is a single-use flexible tube connector and the sixth single-use connector 80 is a single-use sanitary flange connector. Various kinds of sensors such as thermocouple 68, DO sensor 70, pH sensor or conductivity meter are installed in the sensor chamber 66 for detecting liquid properties. Additionally, there is a plurality of extra ports arranged on the sensor chamber 66 for the sampling port 82 and fluid port 84 so as to sample or transmit liquid/gas in the sensor chamber 66. A driving device is used to drive the centrifugal pump head 22. In one embodiment, the driving device is a magnetic bearingless motor 30.

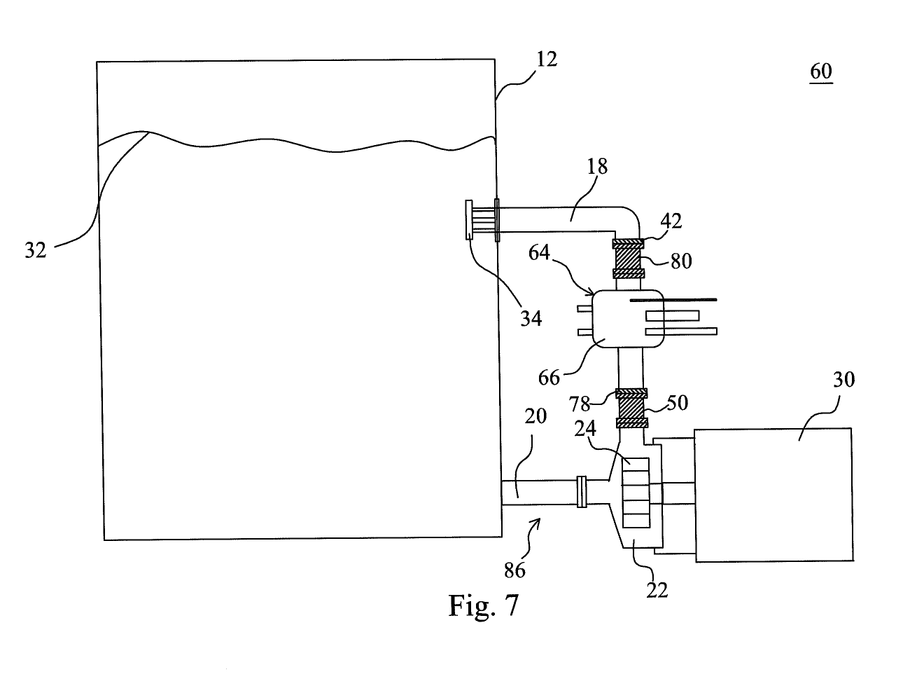

Referring to FIG. 7 according to the fourth embodiment, an external mixing device 60 is formed via connection between the fifth single-use connector 78 of the sensor set 64 and the fourth single-use connector 50, and via connection between the sixth single-use connector 80 of the sensor 64 and the first single-use connector 42. The difference between the fourth and the third embodiment is: in the third embodiment, the centrifugal pump head 22, the sensor set 64, the third single-use connector 48 and the sixth single-use connector 80 form a module 62 for connecting the bag 12; in the fourth embodiment, however, the centrifugal pump head 22 and the outlet pipeline 20/inlet pipeline 18 of the bag 12 form another module 86 for connecting the sensor set 64.

In the fourth embodiment, the bag 12 and the single-use pump head 22 are assembled and packed together to become a module 86 and sterilized by Gamma ray irradiation or other means. After installing all sensors inside and connecting pipelines, the sensor set 64 is steam sterilized alone. After sterilizing the module 86, connect the module 86 to the sensor set 64 and connect the pump head 22 to the magnetic bearingless motor 30. After this, fill the single-use bag 12 with liquid 32 and turn on the magnetic bearingless motor 30 to mix the liquid. The single-use connectors of the sensor set module 64 can be removed and replaced by new single-use connectors after use to become a new set. The set is reusable after sterilization. Types of the connectors and the structure and details of the sensor set 66 are disclosed in the third embodiment and are not elaborated herein any more.

According to the first to the fourth embodiments described above, the centrifugal pump head 22 is a single-use pump head which can be autoclaved and can be dismantled from the magnetic bearingless motor 30. General single-use pumps are available in the market, such as BPS bearingless pump of Levitronix. The single-use centrifugal pump head 22 is a totally closed system; it has an impeller 24 installed inside without any mechanical seal so that inner wall of the pump head 22 will not be touched or worn. Preferably, the inlet pipeline 18 and the outlet pipeline 20 are silicon tubes, C-Flex flexible tubes or tubes of relative materials.

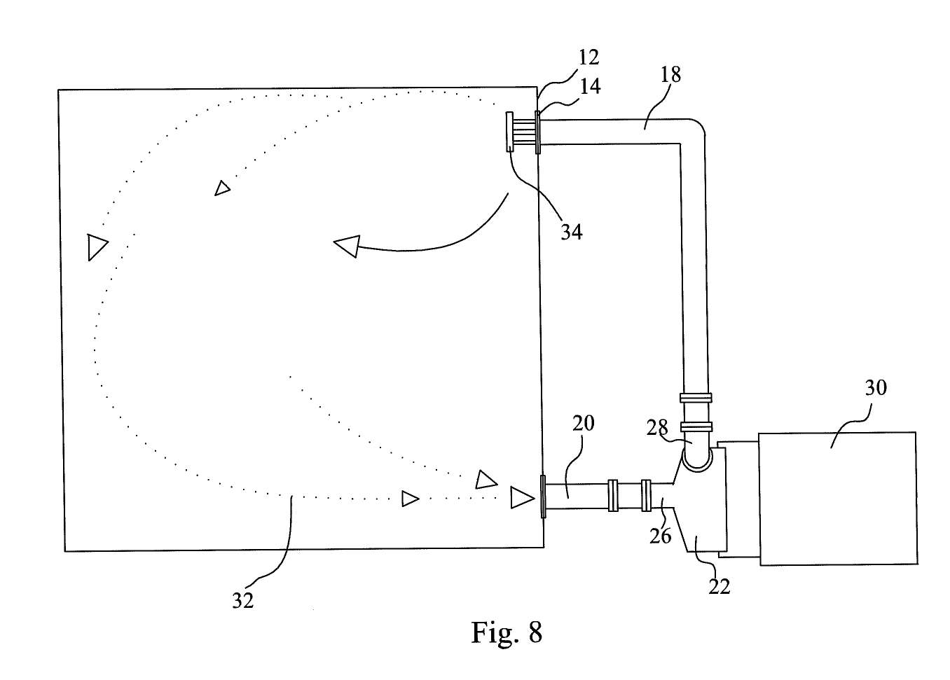

Referring to FIG. 8 according to an embodiment. When turning on the magnetic bearingless motor 30, the liquid 32 in the single-use bag 12 is transmitted from the outlet pipeline 20 and through the intake 26 of the pump head 22 to the inlet pipeline 18 of the single-use bag 12. Transmitting process of the liquid 32 can lead to mixing and circulating effects of the liquid 32. A static mixer 34 can be arranged inside the bag 12 next to the inlet 14 to enhance mixing effect by generating vortex.

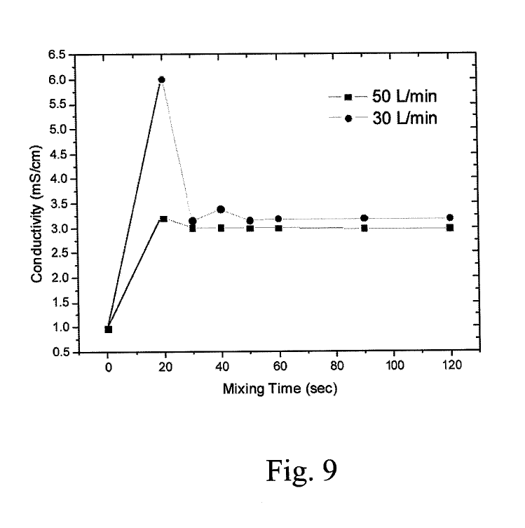

Referring to FIG. 9, it is a schematic diagram illustrating conductivity of the solution against time by operating the external mixing device under different flow rates. Prepare a single-use bag with dimension of 48 cm (W)×48 cm(L)×100 cm(H), wherein the inlet 14 is on the top of the bag 12 and the outlet 16 is on the bottom of the bag 12. A sensor chamber 66 with a conductivity meter 88 installed inside and the centrifugal pump head 22 connects to the inlet pipeline 18 and the outlet pipeline 20 of the bag 12. There is an injection port 90 on the top of the bag 12 for injecting salt water inside. A static mixer 34 is arranged in the bag 12. Fill the bag 12 with 200 liters of water and the inlet 14 is around 10 cm lower than water level. Connect the centrifugal pump head 22 to the magnetic bearingless motor 30 to drive the pump head 22 and set flow rate at 30 L/min. Inject salt water of certain concentration through the injection port 90 into the bag 12 and start to monitor the conductivity of the liquid against time in second via the meter 88 until it reaches stable value. Then set the flow rate at 50 L/min and repeat the operation. Results are shown in FIG. 9, the horizontal axis is Mixing Time (sec) and the vertical axis is Conductivity (ms/cm). The results shows that higher flow rate enhance mixing effect and makes the whole system achieve equilibrium earlier. Anyway, design of the present invention allows the solution to reach equilibrium within 60 seconds and becomes more efficient than before.

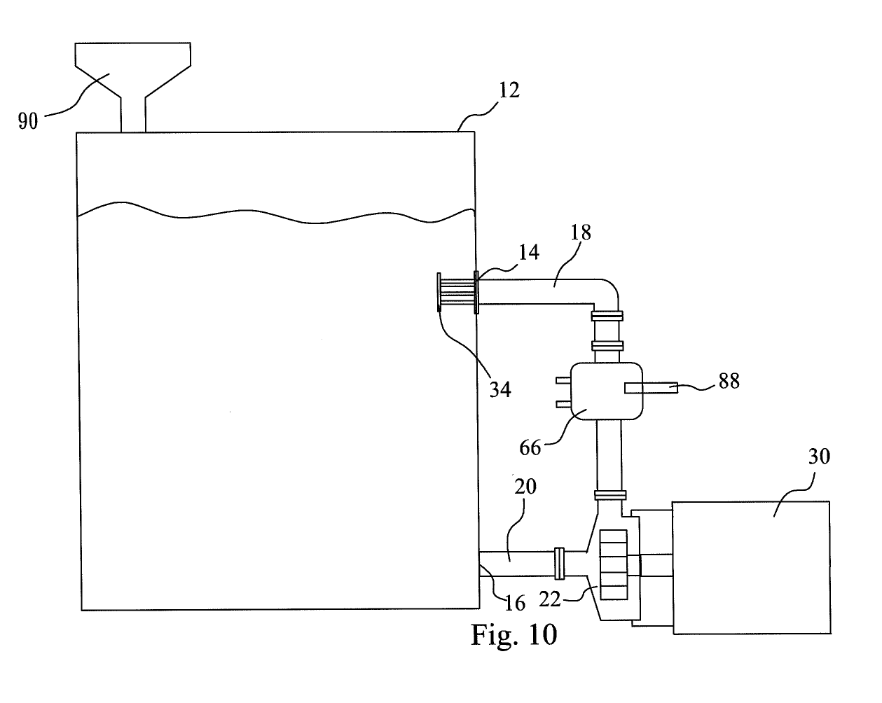

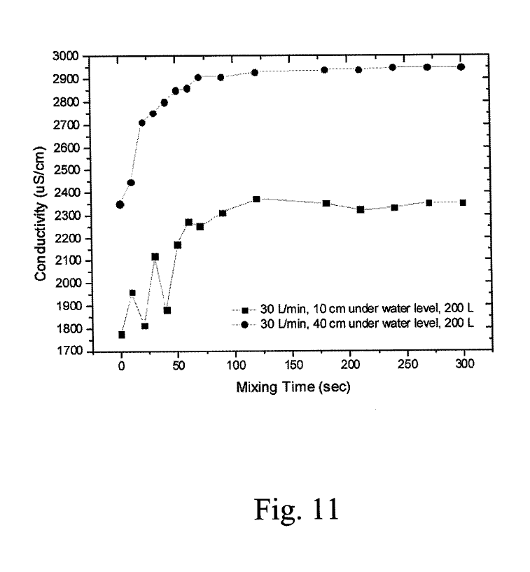

Referring to FIG. 11, it is a schematic diagram illustrating conductivity of the solution against time by operating the external mixing device with different position of inlets. Prepare a single-use bag 12 with dimension of 48 cm(W)×48 cm(L)×100 cm(H), wherein the high inlet 92 and the low inlet 94 are on the side of the bag 12 and the outlet 16 is on the bottom of the bag 12. A sensor chamber 66 with a conductivity meter 88 installed inside and the centrifugal pump head 22 connects to the inlet pipeline 18, 18′ and the outlet pipeline 20 of the bag 12. Fill the bag 12 with 200 liters of water. Open the high inlet 92 and close the low inlet 94 with a clamp; the high inlet 92 is 10 cm lower than the water level at this time. Connect the centrifugal pump head 22 to the magnetic bearingless 30 to drive the pump head 22 and set the flow rate at 30 L/min. Inject salt water of certain concentration through the injection port 90 into the bag 12 and start to monitor the conductivity of the liquid against time in second via the meter 88 until it reaches stable value. After this, open the low inlet 94 and close the high inlet 92; the high inlet is around 40 cm lower than water level at this time. Similarly, set the flow rate at 30 L/min and repeat the operation. Results are shown in FIG. 10, the horizontal axis is Mixing Time (sec) and the vertical axis is Conductivity (ms/cm). The result indicates that at the same flow rate 30 L/min, the mixing effect could be enhanced by adjusting the outlet position at around half of water level.

The present invention proposes an external mixing device which can connects to a single-use container and the mixing container can be replaced with a bag. The external mixing device comprises a centrifugal pump head set. The set comprises a magnetic bearingless motor and a single-use pump head. The centrifugal pump head can be dismantled from the magnetic bearingless motor for sterilization or single-use. The mixing device further comprises a sensor chamber wherein there are a plurality of sensors and extra ports installed for introducing liquid or gas or sampling the liquid. Sensors such as pH sensor, DO sensor, conductivity meter and thermocouple are used to detect liquid properties. Integration of multiple sensors, sampling ports, inlet and outlet into a single set with only an outtake and an intake simplifies the connection to other parts and prevent error operation and contamination. Simple design reduces manufacturing costs and operation risks.

Single-use connectors between the single-use container and the external mixing device are sealed before use and are ready-to-use. They can be connected sterilely under general environment without process of steam sterilization. It is also unnecessary to operate it under sterile environment (e.g. Biological safety cabinets). The mixing device can be autoclaved for sterilization or for single-use. Besides, the volume of the external mixing device is smaller than the bag so that operation procedures are simplified. In addition, the single-use pump comprises an impeller and is a completely closed system without any mechanical seal thereon. The impeller is driven by magnetic force and does not touch or wear the pump head so that it can prevent particles from contaminating the liquid.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An external mixing device, which is used to mix a liquid in a single-use container, comprising:
arranging at least an inlet and an outlet on the single-use container;
a pump head fixed on the single-use container, wherein the pump head comprises an intake and an outtake; the outtake connects to the inlet of the single-use container, the intake connects to the outlet of the single-use container and a mixer is installed inside the pump head; and
a driving device connected to the pump head for driving the mixer so as to let the liquid continuously circulate between the pump head and the single-use container.

2. The external mixing device according to claim 1, wherein the single-use container is a single-use bag and the pump head is a single-use pump head.

3. The external mixing device according to claim 1, wherein the single-use container and the pump head are simultaneously sterilized by gamma ray or ethylene oxide before using the external mixing device.

4. The external mixing device according to claim 1, wherein the mixer is an impeller.

5. The external mixing device according to claim 1, wherein the outtake of the pump head connects to the inlet of the single-use container via at least an inlet pipeline.

6. The external mixing device according to claim 1, it further comprises a holder for supporting the single-use container.

7. The external mixing device according to claim 1, a static mixer is optionally arranged inside the single-use container next to the inlet thereof.

8. An external mixing device, which is used to mix a liquid in a single-use container, comprising:
arranging at least an inlet and an outlet on the single-use container; an inlet pipeline and an outlet pipeline are respectively arranged on the inlet and the outlet; a first single-use connector and a second single-use connector are arranged on the end away from the single-use container of the inlet pipeline and the outlet pipeline;
a pump head set comprising:
a pump head with a mixer installed inside, wherein the pump head comprises an intake and an outtake;
a third single-use connector arranged on the intake for connecting the second single-use connector; and
a fourth single-use connector arranged on the outtake for connecting the first single-use connector so as to connect the single-use container and the pump head via the inlet pipeline and the outlet pipeline; and
a driving device connected to the pump head for driving the mixer so as to let the liquid continuously circulate between the pump head and the single-use container.

9. The external mixing device according to claim 8, wherein the single-use container is a single-use bag.

10. The external mixing device according to claim 8, wherein the single-use container, the inlet pipeline, the first single-use connector, the outlet pipeline and the second single-use connector are simultaneously sterilized by gamma ray before connecting the single-use container to the pump head set.

11. The external mixing device according to claim 8, wherein the pump head is a single-use pump head or a reusable pump head which can be autoclaved for sterilization; the pump head is sterilized by gamma ray or autoclave before connecting the pump head set to the single-use container.

12. The external mixing device according to claim 8, wherein the mixer is an impeller.

13. The external mixing device according to claim 8, wherein the first single-use connector, the second single-use connector, the third single-use connector and the fourth single-use connector are chosen from one of the single-use flexible tube connector and the single-use sanitary flange connector or combination thereof.

14. The external mixing device according to claim 8, it further comprises a holder for supporting the single-use container and the pump head set.

15. The external mixing device according to claim 8, a static mixer is optionally arranged inside the single-use container next to the inlet.

16. An external mixing device, which is used to mix a liquid in a single-use container, comprising:
arranging at least an inlet and an outlet on the single-use container; an inlet pipeline and an outlet pipeline are respectively arranged on the inlet and the outlet; a first single-use connector and a second single-use connector are arranged on the end away from the single-use container of the inlet pipeline and the outlet pipeline;
a module, comprising:
a pump head with a mixer installed inside, wherein the pump head comprises an intake and an outtake;
a sensor set, comprising a sensor chamber connecting a testing inlet pipeline and a testing outlet pipeline and the testing inlet pipeline is attached to the outtake;
a third single-use connector arranged on the intake for connecting the second single-use connector; and
a sixth single-use connector arranged on the end away from the sensor chamber of the testing outlet pipeline, for connecting the pump head, the sensor chamber and the single-use container; and
a driving device connected to the pump head for driving the mixer so as to let the liquid continuously circulate between the pump head, the sensor set, and the single-use container.

17. The external mixing device according to claim 16, wherein the single-use container is a single-use bag.

18. The external mixing device according to claim 16, wherein the single-use container, the inlet pipeline, the first single-use connector, the outlet pipeline and the second single-use connector are simultaneously sterilized by gamma ray before connecting the single-use container to the module.

19. The external mixing device according to claim 16, wherein at least one of the thermocouple, DO sensor, pH sensor and conductivity meter is installed inside the sensor chamber.

20. The external mixing device according to claim 19, wherein the module is autoclaved for sterilization before connecting the single-use container to the module.

21. The external mixing device according to claim 16, wherein at least one extra port is arranged on the sensor chamber.

22. The external mixing device according to claim 16, a static mixer is optionally arranged inside the single-use container next to the inlet.

23. The external mixing device according to claim 16, wherein the first single-use connector, the second single-use connector, the third single-use connector and the sixth single-use connector are chosen from one of the single-use flexible tube connector and the single-use sanitary flange connector or combination thereof.

24. An external mixing device, which is used to mix a liquid in a single-use container, comprising:
arranging at least an inlet and an outlet on the single-use container; an inlet pipeline and an outlet pipeline are respectively arranged on the inlet and the outlet; a first single-use connector is arranged on one end of the inlet pipeline;
a pump head with a mixer installed inside, wherein the pump head comprises an intake and an outtake; a fourth single-use connector is arranged on the outtake of the pump head and the intake of the pump head is attached to the outlet;
a sensor set, comprising a sensor chamber connecting a testing inlet pipeline and a testing outlet pipeline; a fifth single-use connector is arranged on the end of the testing inlet pipeline for connecting the fourth single-use connector; a sixth connector is arranged on the end of the testing outlet pipeline for connecting the first single-use connector; and
a driving device connected to the pump head for driving the mixer so as to let the liquid continuously circulate between the pump head, the sensor set, and the single-use container.

25. The external mixing device according to claim 24, wherein the single-use container is a single-use bag.

26. The external mixing device according to claim 24, wherein the single-use container, the inlet pipeline, the first single-use connector, the outlet pipeline, the second single-use connector, the pump head and the fourth single-use connector are sterilized by gamma ray before connecting the single-use container/the pump head to the sensor set.

27. The external mixing device according to claim 24, wherein at least one of the thermocouple, DO sensor, pH sensor and conductivity meter is installed inside the sensor chamber.

28. The external mixing device according to claim 27, wherein the sensor set is autoclaved for sterilization before connecting the sensor set to the single-use container/the pump head.

29. The external mixing device according to claim 24, wherein at least one extra port is arranged on the sensor chamber.

30. The external mixing device according to claim 24, a static mixer is optionally arranged inside the single-use container next to the inlet.

31. The external mixing device according to claim 24, wherein the first single-use connector, the fourth single-use connector, the fifth single-use connector and the sixth single-use connector are chosen from one of the single-use flexible tube connector and the single-use sanitary flange connector or combination thereof.
